(19) United States
(12) Patent Application Publication
(10) Pub. No.: US 2017/0175643 A1
(43) Pub. Date: Jun. 22, 2017

(54) SYSTEM FOR THE EMERGENCY STARTING OF A TUROMACHINE

(71) Applicant: SAFRAN HELICOPTER ENGINES, Bordes (FR)

(72) Inventor: Jean-Louis Robert Guy BESSE, Nay (FR)

(21) Appl. No.: 15/116,169

(22) PCT Filed: Feb. 6, 2015
(86) PCT No.: PCT/FR2015/050290

§ 371 Date: Aug. 2, 2016

(30) Foreign Application Priority Data
Feb. 10, 2014 (FR) 1451020

(51) Int. Cl. F02C 7/262; F01D 19/00; F42B 3/04; F02C 7/272

(52) U.S. Cl. CPC F02C 7/262; F02C 7/272; F01D 19/00; F42B 3/04; F05D 2260/85

(57) ABSTRACT

The invention relates to a system for emergency starting a turbine engine, characterised in that it comprises a flyer for driving the turbine engine, said flyer comprising a drum (2) rigidly connected to a rotary shaft (3), the axes of symmetry (LL) of the drum (2) and of the shaft being coincident, the flyer further comprising at least one exhaust nozzle (4) for ejecting gas, which is positioned on the periphery of the drum (2) and oriented substantially tangentially to the rotation about said axis (LL), and a pyrotechnic gas generation device which is installed in the flyer and feeds said at least one exhaust nozzle (4), said emergency start system further comprising a support in which the shaft of the flyer rotates, and a volute for recovering the gases, which radially surrounds the flyer and is rigidly connected to said support.

### FIELD OF THE INVENTION

The present invention relates to the field of rotary pyrotechnic actuators, in particular for use in rotating machines, such as for starting up turbine engines. More particularly, the invention relates to an emergency start system for bringing a turbine engine to its nominal operating speed within a limited period of time.

### PRIOR ART

In the case of a multi-engined aircraft, for example, one or more engines can be shut down during certain flight phases depending on the power requirements. They may then need to be urgently restarted for an unplanned manoeuvre or because of an engine fault.

Regarding turbine engines in particular, a main start-up system (often an electrical starter) allows the engine to be activated during normal, routine operating conditions. Generally, this main start-up system does not allow the nominal speed to be reached within the space of time required during an emergency.

To gather the power required to rotate the turbine engine within a short time, systems specifically for emergency starts can use pyrotechnic hot-gas generators. This is the case in systems, as described in FR2862749, which inject the hot gases into the primary circuit so that they expand in the high-pressure turbine that is rotating the entire turbine engine. The end of the start-up sequence is equivalent to the ignition of the combustion chamber, which is supplied with air and fuel, and this ignition allows the turbine engine to take over at the desired power.

A pyrotechnic starter using this principle can be easy to design and is well suited to single-use applications, like a missile for example. On the other hand, the hot gases coming from the combustion of the propellant can have a detrimental effect on the mechanical strength of the hot parts of the turbine engine downstream of their injection apertures. Furthermore, these apertures have to be fitted with a stopper which closes at the end of the emergency start if the starter is decoupled from the vehicle after use.

Other emergency start systems can use the high-energy gases coming from the pyrotechnic gas generator to actuate a turbine or a displacement motor, as described in

FR299004, in order to rotate the turbine engine.

Generally, a transmission including a gear train adapts the rotational speed of the starter to that of the turbine engine. In addition, idle rotation of the motor of the starter has to be prevented during normal operating phases of the turbine engine on which said starter is permanently installed. Indeed, constant rotation of the system would lead to the starter aging despite not being in operation, and consumes energy owing to the mechanical or aerodynamic friction in the motor of the starter running idle. Therefore, this type of starter has to be decoupled from the turbine engine when not in operation, by means of a declutching or freewheeling system in the case of a turbine. These factors have a detrimental effect on the weight and complexity of the system.

The object of the invention is to propose a system for emergency starting a turbine engine that makes use of the advantages of a pyrotechnic gas generator while avoiding the drawbacks involved with the known solutions in terms of their size, their complexity, or their impact on the wear of the turbine engine, in order to fit them permanently.

In addition, despite being discussed in relation to turbine engines, the problem of causing rotating machines to rotate in order to quickly reach a nominal speed relates to other applications. Therefore, the invention seeks a system for quick start-up that is simple to incorporate on a rotating machine and is independent in terms of its mode of operation. In this respect, other applications of this pyrotechnic rotary actuator that require a high power density in a short period of time are also conceivable, for example, a standby single-use traction system.

### DISCLOSURE OF THE INVENTION

In this regard, the invention relates to a system for emergency starting a turbine engine, characterised in that it comprises a flyer for driving the turbine engine, said flyer comprising a drum rigidly connected to a rotary shaft, the axes of symmetry of the drum and the shaft being coincident, the flyer further comprising at least one exhaust nozzle for ejecting gas, which is positioned on the periphery of the drum and oriented substantially tangentially to the rotation about said axis, and a pyrotechnic gas generation device which is installed in the flyer and feeds said at least one exhaust nozzle, said emergency start system further comprising a support in which the shaft of the flyer rotates, and a volute for recovering the gases, which radially surrounds the flyer and is rigidly connected to said support.

In other words, the exhaust nozzles produce tangential gas ejection jets that make it possible to produce a torque on the flyer shaft. The system can thus be used to drive a turbine engine by the shaft of the system being coupled to the input gearing of said turbine engine. With regard to a single usage, the pyrotechnic device allows gases to be generated in a chamber upstream of the exhaust nozzles at a high pressure and temperature, thus creating thrust and therefore the torques required for driving a turbine engine up to the speeds corresponding to its nominal operating speed. The fact that this pyrotechnic device is installed in the flyer reduces the transfer problems and the losses during the operation thereof. Moreover, the principle of the flyer means that it can be positioned on the turbine engine and said turbine engine can drive the flyer during normal operation, i.e. when the emergency start system is not operating. Indeed, the flyer creates few friction losses and is not at risk of being used prematurely.

Preferably, the gas generation device comprises a solid propellant block. This makes it simpler to maintain the device. It is thus conceivable to replace the pyrotechnic device in a simple manner after use.

Advantageously, the gas generation device comprises a combustion chamber which feeds said at least one exhaust nozzle and is formed within the solid propellant block.

In addition, said at least one exhaust nozzle can be a two-dimensional exhaust nozzle. This allows the flyer to have a more compact design and to be simpler to produce.

Preferably, since the flyer has a direction of rotation defined by the orientation of the exhaust nozzles, the volute has an opening at one angular sector around the axis of rotation of the flyer, and the cross section of the stream from the volute changes, by rotating in the direction of rotation of the flyer, from one edge to the other of the angular sector that is complementary to the angular sector of the opening. Indeed, the shape of the volute helps to expand the gases exiting the exhaust nozzles, and thus, by means of the thrust from said nozzles, contributes to the torque provided by the flyer. It is therefore important to optimise the shape of the volute. In addition, this shape allows the hot gases that exit the exhaust nozzles to be discharged radially in relation to the axis, thus limiting the extent to which the equipment around the flyer heats up.

Advantageously, the emergency start system comprises a means for igniting the pyrotechnic gas generation device, which means can be placed in armed or disarmed mode. In particular, this prevents the system from being ignited at the incorrect time.

The invention also relates to a turbine engine comprising a system according to the invention and a shaft and a transmission means which couples the shaft of the flyer to the shaft of the turbine engine, the support being held in a stationary manner relative to a casing of the transmission means. Since the flyer operates independently of the turbine engine, it can be positioned externally, for example attached to the casing of the auxiliary gearbox, and the turbine engine can be protected from the effect of the ejection gases. For example, since the turbine engine further comprises an outlet exhaust nozzle, the volute can open into a pipe that supplies the expanded gases into said outlet exhaust nozzle of the turbine engine. The pyrotechnic starter can also be mechanically coupled to a main start-up system of said turbine engine.

### BRIEF DESCRIPTION OF THE DRAWINGS

The present invention will be better understood, and other details, features and advantages of the present invention will become clearer upon reading the following description, given with reference to the accompanying drawings, in which:

FIG. 1 is a perspective view of a flyer of a start-up system according to the invention.

FIG. 2 is a section through half a flyer of a start-up system according to the invention, in a plane perpendicular to the axis of rotation and passing through the exhaust nozzles.

FIG. 3 is a longitudinal section through an emergency start system according to the invention prior to use.

FIG. 4 is a schematic perspective view of one arrangement of the means for discharging the gases on an emergency start system according to the invention.

FIG. 5 is a schematic section, in a plane perpendicular to the axis of rotation, through the volute for discharging the gases and through the flyer of a system according to the invention.

FIG. 6 is a longitudinal section through an emergency start system according to the invention at the start of the ignition thereof.

FIG. 7 is a longitudinal section through an emergency start system according to the invention towards the end of its ignition.

FIG. 8 is a diagram showing how an emergency start system according to the invention is installed on a turbine engine.

### DETAILED DESCRIPTION OF THE INVENTION

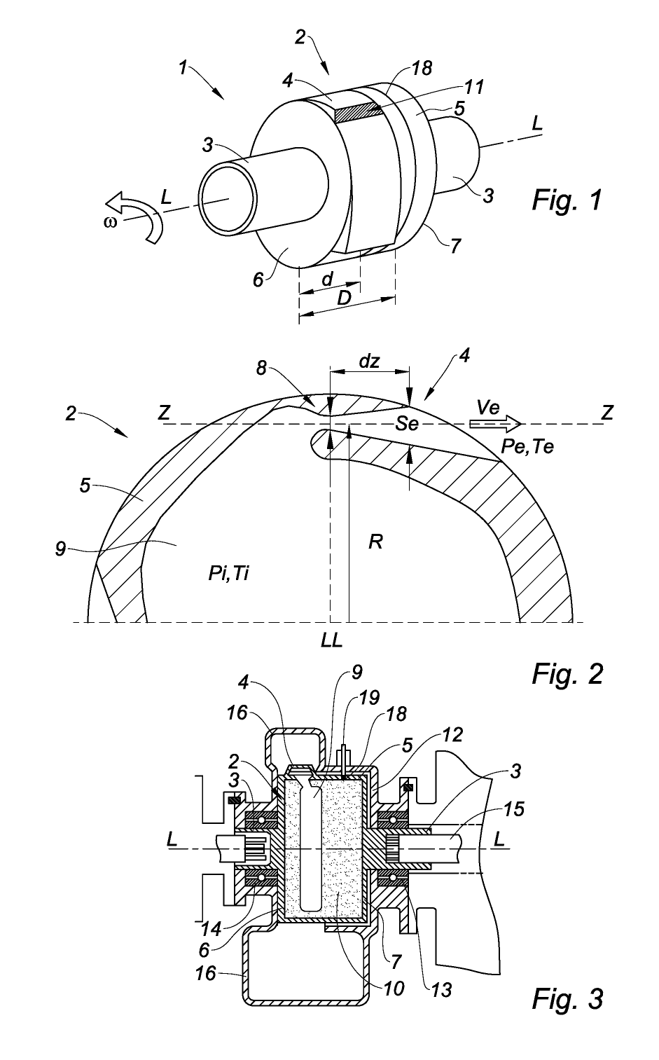

With reference to FIGS. 1 to 3, the invention relates to a system capable of rotating a shaft by producing a torque that is sufficient to start up a turbine engine. This system comprises a flyer 1 consisting of a cylindrical drum 2 and a rotary shaft 3, which are rigidly interconnected and have the same axis LL.

With the drum 2 having a given width D along the axis of rotation LL, a plurality of exhaust nozzles 4 are arranged on a narrower strip, of width d, of the peripheral cylindrical wall 5 of said drum. This strip is located at one side of the cylindrical wall 5 of the drum 2. With reference to FIGS. 1 and 2, if, for example, the left transverse surface is denoted the upper surface 6 of the drum 2 and the right transverse surface is denoted the lower surface 7 of the drum, the strip in which the exhaust nozzles 4 are located can, for example, be off-centre as shown, and close to the upper surface 6. The exhaust nozzles 4 are oriented tangentially to the cylindrical wall 5, all facing the same direction. This direction is the same as that of the gas jet that should exit said nozzles, and therefore, by way of reaction, it causes the flyer 1 to rotate during operation in the opposite direction to that of the gas jet. In the example, the exhaust nozzles 4 are distributed evenly in azimuth, and there are three of them, with two being visible in FIG. 1.

Still referring to the example, the exhaust nozzles 4 are two-dimensional. This means that they are defined by their shape in a sectional plane transverse to the axis of rotation LL. With reference to FIG. 2, the exhaust nozzle 4 forms a duct of length dz that diverges starting from a neck 8, which has the minimum cross section. This neck 8 is located on a radius R of the axis LL of the flyer 1, and the exhaust nozzle 4 is oriented along an axis ZZ that is substantially perpendicular to the radius passing through the neck 8.

Alternatively, it is possible, for example, to design the exhaust nozzles 4 to have an asymmetric shape, depending on the required ease of design and production. In this case, said exhaust nozzles are still defined as a diverging duct oriented along an axis ZZ.

Via the neck 8, the exhaust nozzle 4 is in communication with a combustion chamber 9, which should contain pressurised gas when the flyer 1 is in operation. In the example shown, this combustion chamber 9 is shared by the three exhaust nozzles 4 positioned on the cylindrical wall 5 of the drum 2.

Therefore, a gas generator is required in order to fill the combustion chamber 9 with pressurised gas. With reference to FIG. 3, which shows the flyer 1 prior to use, it can be seen that the drum 2 forms a cavity between its cylindrical wall 5 and its upper surface 6 and lower surface 7. The internal cavity in the drum 2 is filled by a solid block 10 of a material designed to produce hot gases when set alight by an ignition device, which is positioned in the region of the combustion chamber 9 but not shown in the drawings. This material is generally made of solid propellant. The space left free in the drum 2 between the strip occupied by the nozzles 4 and the lower surface 7 is of such a size as to form a sufficient store of propellant, the combustion of which will generate gases for the necessary period of time to start up the turbine engine.

In the flyer 1, before use, the combustion chamber 9, which feeds the exhaust nozzles 4 and is intended for receiving the gases produced by the combustion of the propellant, is dug out of the propellant block 10 and occupies less space in the region of the exhaust nozzles. Preferably, the exhaust nozzles 4 are sealed by a membrane 11, which is ejected by the pressure during ignition, thus preventing dust and moisture from entering the combustion chamber 9.

To form an emergency start system of a turbine engine, the flyer 1 is incorporated on a support 12 comprising bearings 13, 14, in which the shaft 3 rotates. As shown, the shaft 3 is intended to be coupled to a shaft 15 that drives the turbine engine. In the solution shown, this shaft 15 drives the turbine engine by means of a system of gears (not shown) to multiply/reduce the correct rotational speed. On the other hand, said shaft is coupled, for example by means of splines, on the shaft 3 of the flyer 1, and is designed to break if the transmitted torque accidentally exceeds a maximum permissible value.

As shown in FIGS. 3 to 5, the support 12 includes a volute 16. This volute 16 radially surrounds the flyer 1. The volute is designed to allow the gases exiting the nozzles 4 to expand before discharging them. Together with the portion of the support 12 that surrounds the drum 2, the volute forms a duct 16 which winds around the flyer 1. The internal wall of this duct 16 is open opposite the passage for the exhaust nozzles 4 in order to collect the gases exiting said nozzles. In the example shown, the radial cross section of the duct formed by the volute 16 is substantially rectangular.

With reference to FIG. 5, the cross section of the external wall of the volute 16 has a spiral shape around the axis LL of the flyer 1. If φ denotes the azimuth around the axis LL, the distance from the external wall of the volute 16 to the axis follows a law S(φ), which increases steadily in this example, as a function of φ between a point A and a point B in the direction of rotation corresponding to that of the flyer 1 during operation. In FIG. 5, the direction of rotation is anticlockwise and corresponds to nozzles 4 oriented as in FIG. 2.

In addition, the width of the volute 16 along the axis LL increases in this example from A to B. This is shown by the sections shown in FIGS. 3, 6 and 7, which show the cross section of the volute 16 in the longitudinal sectional half-planes passing through point A (at the top) and point C (at the bottom), which is an intermediate point between A and B and shown in FIG. 5. The cross section of the duct formed by the volute 16 thus changes (increases in the example given here) steadily, according to a law S(φ), between the points A and B in azimuth φ to guide the expansion of the gases.

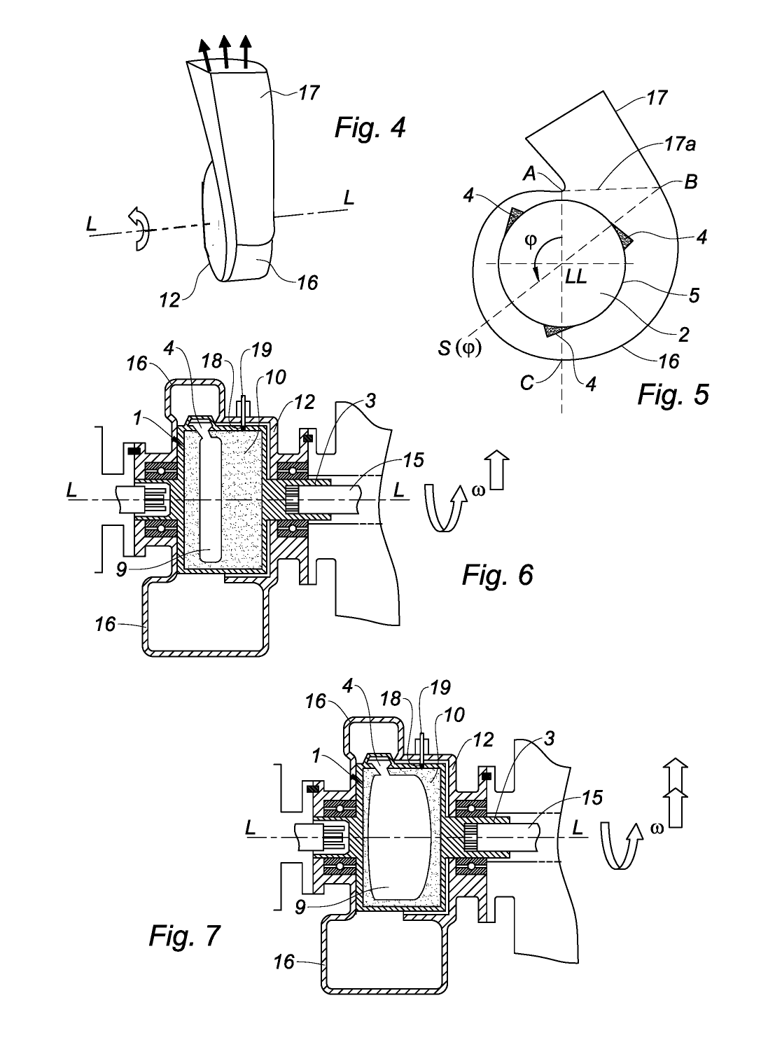

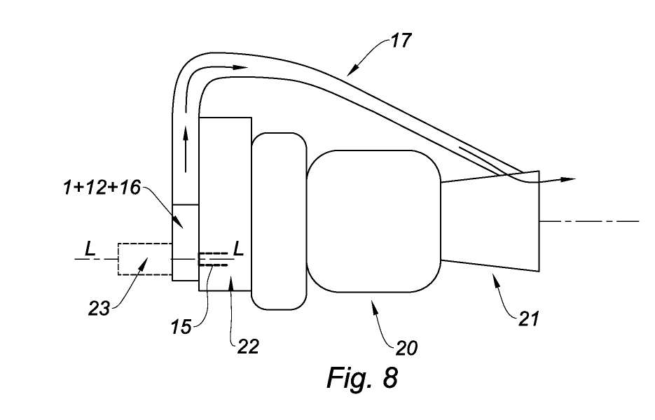

By means of the opening 17a defined in azimuth between the points B and A, the volute 16 opens into a conduit 17 for discharging the gases, as shown in FIGS. 4 and 5. Depending on the type of setup, these gases can be discharged directly into the atmosphere. With reference to FIG. 8, when the system is fitted on a turbine engine 20, the conduit 17 can open into the outlet exhaust nozzle 21. This allows the hot gases exiting the flyer 1 to be ejected into an environment already provided to withstand the temperature conditions of the gases, and also makes it possible to protect the turbine engine and to take advantage of pressure conditions that promote the ejection of said gases.

With reference to FIG. 6, when the propellant block 10 is ignited, the combustion starts in the combustion chamber 9, which is in its initial shape as shown in FIG. 3. The combustion chamber 9 fills with pressurised gas and is used as a chamber for supplying the exhaust nozzles 4 with high-energy gas at specified temperature conditions Ti and pressure conditions Pi. This gas exits through the exhaust nozzles 4, thus generating thrust and producing a torque that causes the flyer 1 to rotate at a speed w. With reference to FIG. 5, as the combustion progresses, the propellant is used up and the volume of the combustion chamber 9 of the exhaust nozzles 4 changes in the block 10 until all the propellant has been used. It is routine practice for a person skilled in the art to determine the initial shape of the combustion chamber 9 and the initial weight of the propellant block 10 so that the pressure conditions Pi and temperature conditions Ti of the gases in the combustion chamber 9 change during this process to provide the torque according to a desired variation over the required time.

During the propellant combustion phase, the pressure Pi is sufficiently high for each of the exhaust nozzles 4 to be primed by a sonic flow to the neck 8. At its outlet cross section, each exhaust nozzle 4 thus creates a gas jet in the direction ZZ tangential to the neck 8. At the outlet cross section Se of the exhaust nozzle 4, this jet reaches a high speed Ve, whereas the pressure Pe and the temperature Te of the gases have reduced compared with those of the gases in the combustion chamber 9. This produces a tangential force F, also referred to as thrust, in the opposite direction to the speed Ve, which is dependent on the mass flow rate, on the speed of the jet passing therethrough and on the difference between this outlet pressure Pe of the jet and a static pressure around the flyer 1 in the volute 16. The torque provided by the flyer 1 on the rotary shaft 3 is the sum of the torques, which, for each exhaust nozzle 4, is this force F multiplied by the radius R of the neck 8.

In a suitable embodiment, the neck 8 is made in and formed, for example, of an abradable, woven and stamped material, such as carbon/ceramics or any other device, so as to reduce as much as possible the transfer of heat by conduction and radiation from the hot gases to the drum 2 when the propellant is combusted. It goes without saying that the configuration shown in the drawings is just one example. A person skilled in the art will adapt the number of exhaust nozzles 4, the size thereof and the distribution thereof in azimuth depending on the torque to be provided and the gas pressure available in the combustion chamber 9. In addition, although the two-dimensional shape of the exhaust nozzles 4 is advantageous in terms of size for the system, it is conceivable to use other shapes, in particular an axisymmetric shape.

Moreover, the shape of the volute 16 contributes to the output of the exhaust nozzles 4 and thus to the performance of the flyer 1 when ignited. The combustion gases ejected at the speed Ve, pressure Pe and temperature Te from each of the exhaust nozzles 4 continue to expand in the volute 16 as the exhaust nozzle 4 rotates inside the volute 16, and are then discharged to the outside via the exit conduit 17.

With reference to FIG. 5, the distribution of the cross section of the volute 16 according to the azimuth cp between points A and B is optimised to achieve a good balance between the level of expansion, which determines the torque provided by the flyer 1, and a gas ejection temperature Te that is compatible with the area surrounding the system. In particular, this balance takes account of the forced-convection phenomena in the volute 16, the conduction by the means for fastening the device, and the thermal radiation from the assembly.

In addition, the volute 16 contributes to protecting the equipment surrounding the flyer 1 by guiding the gases ejected through the exhaust nozzles 4 towards the conduit 17.

Moreover, the protective membrane 11 that seals each exhaust nozzle 4 while the flyer 1 is not in use is designed to be disintegrated upon ignition under the combined effect of the pressure and the temperature of the gases coming from the combustion of the propellant. The remains of said membrane are thus discharged naturally with the gases when the flyer 1 starts up.

With reference to FIGS. 1 and 3, to trigger the combustion of the propellant block 10, the start-up system uses an electrical control in the example shown. In the flyer 1, the device (not shown in the drawings) for igniting the aforementioned propellant block 10 is connected to a circular contact track 18 flush with the surface of the cylindrical wall 5 of the drum 2. An electric sliding contact breaker 19 is positioned in contact with the contact track 18 on the support 12 to send an electric current to the ignition device. The contact breaker 19 is in turn connected to a control system (not shown) that sends the current, via said ignition device, to set the propellant alight in the event of an emergency start.

Preferably, the system for controlling the ignition device is designed to be armed, i.e. ready to transmit a sufficient current to trigger the combustion, or disarmed, i.e. prevented from doing so. The disarmed position is advantageous in that it avoids accidental ignitions.

The invention also covers the possibility of using other ways of igniting the propellant block 10, for example a wireless connection using optical or laser means.

With reference to FIG. 8, an advantageous setup for a turbine engine 20 involves attaching the support 12 on the auxiliary gearbox casing 22, shown here upstream of the turbine engine 20. As shown in FIG. 8, this optionally allows the pyrotechnic emergency starter to be connected in series, at its other end, to the main starter 23 of the turbine engine. This main, generally electrical starter 23 is typically used to start up the turbine engine 20 normally.

It should be noted that the flyer 1 does not introduce extra gearing. Moreover, said flyer is a small rotary part having low inertia and low aerodynamic drag. Therefore, it can be positioned easily in series between the main starter 23 and the turbine engine 20, ready for possible emergency use without creating significant performance losses.

Owing to these different features, the operating principle of the flyer 1 as a means for emergency starting an aircraft turbine engine 20, in a setup as shown in FIG. 8, corresponds to the choice between three states described below.

A first, disarmed state corresponds to the case in which the turbine engine 20 is operating normally. The engine is used, for example, together with the other turbine engines of the aircraft to provide the nominal power for the current flight conditions. In this case, the shaft 15 rotates the flyer 1. For its part, the system for controlling the device for igniting the propellant block 10 is disarmed. Optionally, the control system either continuously sends or intermittently sends upon request a weak electrical signal to the device for igniting the propellant block 10 in order to detect possible interruptions in the control chain. If a fault is confirmed by the logic of this system, the fault is processed accordingly and a suitable signal is generated.

This first disarmed state corresponds exactly to the case in which the turbine engine is starting up normally. In this case, it is the main starter that rotates the flyer 1 at the same time as the turbine engine 20.

The second, armed state corresponds to the flight conditions in which the turbine engine 20 is put on standby compared with the other turbine engines of the aircraft. In this case, either the turbine engine 20 is idling and rotating the flyer 1, or it is simply stopped. The system for controlling the device for igniting the propellant block 10 is armed in this case. The electrical connection between the contact breaker 19 and the contact track 18 still allows potential anomalies to be detected on the emergency start system, and for the fault to be processed accordingly and suitable signals generated.

The third, ignited state corresponds to the case in which an emergency start command is sent. The ignition command can only be effective if the system for controlling the device for igniting the propellant block 10 is armed. The design of the installed system does not allow the state to change directly from the first to the third.

By following the ignition phases of the flyer 1 as described with reference to FIGS. 6 and 7, it is now the flyer 1 that produces a torque and drives the turbine engine 20. The entire system is designed to allow the rotational speed w of the flyer 1 to quickly reach the necessary speed for the turbine engine to provide the expected power. In addition, the main starter is also activated, as are the ignition system and fuel metering system of the turbine engine, according to the established laws to ensure said turbine engine is brought to speed once the flyer 1 has finished operating.

The described emergency start system is not limited to the configuration shown in FIG. 8 or even to the emergency starting of a turbine engine. As set out at the outset, it can for example be used as a standby single-use traction system to provide a high power density in a short period of time. It is also conceivable to design a setup using several systems according to the invention coupled to the same shaft. It may thus be advantageous to produce just one type of system and to adjust how many of them are fitted depending on the required power.

1. A system for emergency starting a turbine engine, characterised in that it comprises a flyer for driving the turbine engine, said flyer comprising a drum rigidly connected to a rotary shaft, the axes of symmetry of the drum and of the shaft being coincident, the flyer further comprising at least one exhaust nozzle for ejecting gas, which is positioned on the periphery of the drum and oriented substantially tangentially to the rotation about said axis , and a pyrotechnic gas generation device which is installed in the flyer and feeds said at least one exhaust nozzle, said emergency start system further comprising a support in which the shaft of the flyer rotates, and a volute for recovering the gases, which radially surrounds the flyer and is rigidly connected to said support.

2. A system according to claim 1, wherein the gas generation device comprises a solid propellant block.

3. A system according to claim 2, wherein a combustion chamber feeding said at least one exhaust nozzle is formed in the solid propellant block.

4. A system according to claim 1, wherein said at least one exhaust nozzle is a two-dimensional exhaust nozzle.

5. A system according to claim 1, wherein, since the flyer has a direction of rotation defined by the orientation of the exhaust nozzles, the volute has an opening at one angular sector around the axis of rotation of the flyer, and the cross section of the stream from the volute changes steadily, by rotating in the direction of rotation of the flyer, from one edge to the other of the angular sector that is complementary to the angular sector of the opening.

6. A system according to claim 1, further comprising a means for igniting the pyrotechnic gas generation device, it being possible to place said ignition means in armed mode or deactivated mode.

7. A turbine engine comprising a system according to claim 1, said turbine engine comprising a shaft and a transmission means which couples the shaft of the flyer to the shaft of the turbine engine, the support being held in a stationary manner relative to a casing of the transmission means.

8. A turbine engine according to claim 7 further comprising an outlet exhaust nozzle and wherein the volute opens into a pipe that supplies the gases into said outlet exhaust nozzle.

9. A turbine engine according to claim 7, further comprising a main start-up system and wherein said drive system is mechanically coupled to said main start-up system.
